(19) United States
(12) Patent Application Publication
(10) Pub. No.: US 2004/0079747 A1
(43) Pub. Date: Apr. 29, 2004

(54) Portable electric heating cooker

(76) Inventor: Donglei Wang, Zhuhai City (CN)

Correspondence Address: Charles E. Baxley, Esquire, Third Floor, 90 John Street, New York, NY, 10038, US

(21) Appl. No.: 10/687,393

(22) Filed: Oct. 15, 2003

(30) Foreign Application Priority Data
Oct. 16, 2002 (TW) 02248706.9

(51) Int. Cl. F27D 11/00

(52) U.S. Cl. 219/438

(57) ABSTRACT

This invention discloses a portable electric heating cooker comprising a handle, a cover, a cooker bowl and a base, inside said base are installed heating means and control means, wherein, two or more than two joining means are provided on said cooker, said joining means can be used to make said cooker into an integral and portable body when necessary. A sealing ring may be further included. With said sealing ring, said cover can be pressed on said cooker bowl tightly, so as to prevent leakage when carrying. A partition board may be installed inside said cooker bowl, so that, different kinds of food or food of different tastes may be braised or broiled in the same cooker.

### TECHNICAL FIELD

This invention relates to a portable electric heating cooker.

### BACKGROUND OF THE INVENTION

Currently, conventional electric heating apparatus for cooking, such as saucepots, electric ovens, are used indoors. Since people have more and more outdoor activities, such as outings, picnics, it is more and more desired to use various cooking apparatus outdoors. However, due to the deficiency in design, these cooking apparatus are not portable and not convenient for use.

### SUMMARY OF THE INVENTION

The main object of the present invention is to provide a portable electric heating cooker, which is especially applicable to saucepots and electric ovens. Said cooker is portable and can improve heating efficiency, keep warm and prevent leakage.

The cooker according to the present invention comprises a handle, a cover, a cooker bowl and a base, inside said base are installed heating means and control means, wherein, two or more than two joining means are provided on said cooker, said joining means can be used to make said cooker into an integral and portable body when necessary.

A sealing ring may be further included which is installed at the brim of said cover or at the brim of said cooker bowl. With said sealing ring, said cover can be pressed on said cooker bowl tightly, so as to prevent leakage when carrying.

A partition board may be installed inside said cooker bowl, so that, different kinds of food or food of different tastes may be braised or broiled in the same cooker.

### BRIEF DESCRIPTION OF THE DRAWINGS

FIG. 1 is an explosive diagram of said portable electric heating cooker;

FIG. 2 is an overall schematic view of said portable electric heating cooker;

FIG. 3 is a schematic view illustrating the cover and the cooker bowl of said portable electric heating cooker;

FIG. 4 is a schematic view illustrating the cooker bowl with a partition board.

### DETAILED DESCRIPTION OF THE PREFERRED EMBODIMENT

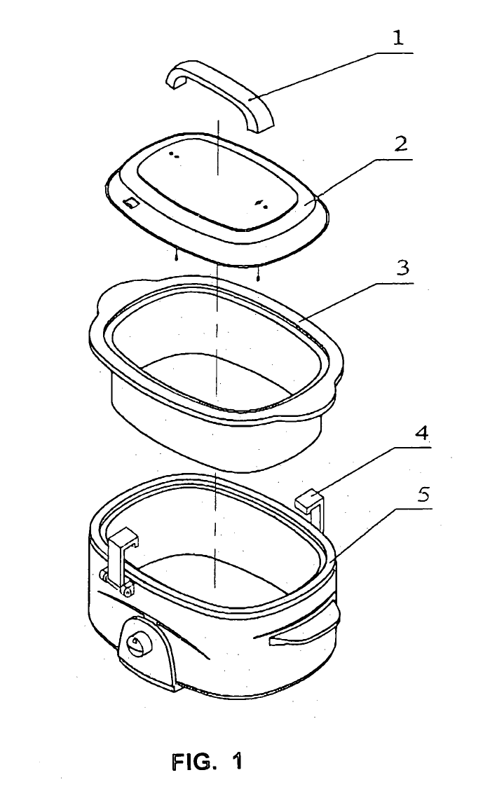

As shown in FIG. 1, the portable electric heating cooker according to the present invention comprises a handle 1, a cover 2, a cooker bowl 3, a joining means 4 and a base 5 with the heating means and control means installed inside. Said handle 1 is for taking and placing the cover. Said cover 2 is for keeping warm and preventing dust. Said cooker bowl 3 is for braising or broiling food. Said joining means 4 is connected with the base 5 by hinge, said joining means can be used to join the cooker into an integral body when necessary for portable carrying. Said base 5 is equipped with heating means and control means inside, and provides energy for braising or broiling by said heating means therein.

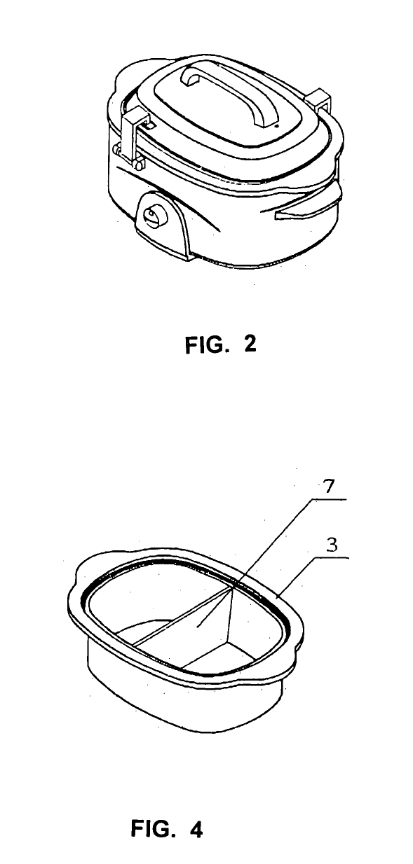

As shown in FIG. 2, said electric heating cooker is joined into an integral body by said joining means, so that, the cooker can be carried with a single hand and is convenient for taking outdoors.

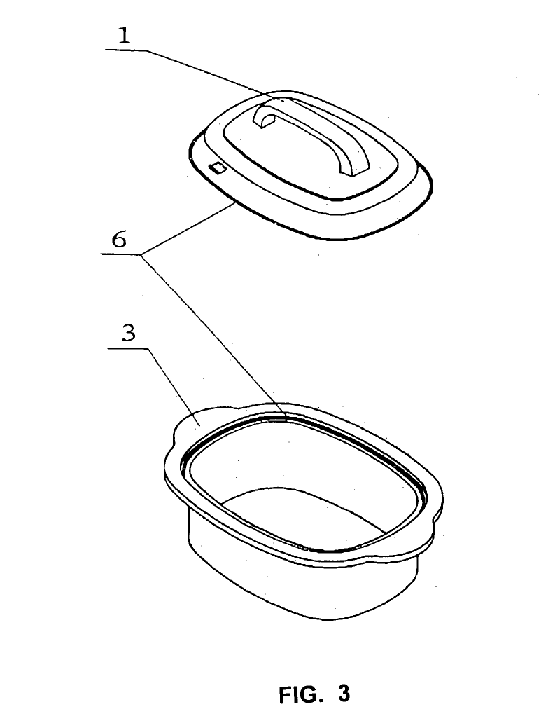

As shown in FIG. 3, a sealing ring 6 is secured at the brim of said cover 2 or at the brim of said cooker bowl 3. With the aid of said joining means or other mechanism, said cover can be pressed on said cooker bowl tightly, so as to prevent leakage when carrying. Said sealing ring is sealed by the force passed from said joining means, or by the joining mechanism between said cover and said cooker bowl, such as screws or couplings, etc.

As shown in FIG. 4, a partition board 7 is installed inside said cooker bowl to separate the cooker bowl into two or more parts. Said partition board may be secured to said cooker bowl or may be moveable.

What is claimed is:

1. A portable electric heating cooker, comprises a handle, a cover, a cooker bowl and a base, inside said base are installed heating means and control means, wherein, at least two joining means are provided on said cooker, said joining means can be used to make said cooker into an integral and portable body when necessary.

2. A portable electric heating cooker according to claim 1, wherein, a sealing ring is secured at the brim of said cover or at the brim of said cooker bowl, with said sealing ring, said cover can be pressed on said cooker bowl tightly.

3. A portable electric heating cooker according to claim 2, wherein, said sealing ring is sealed by the force passed from said joining means, or by the joining mechanism between said cover and said cooker bowl, such as screws or couplings, etc.

4. A portable electric heating cooker according to claim 1, wherein, partition boards are installed inside said cooker bowl to separate said cooker bowl into at least two parts, said partition board may be secured to said cooker bowl or may be moveable.

5. A portable electric heating cooker according to claim 1, wherein, said joining means is connected to the cooker bowl or the cover by hinge or by other connecting mechanism, and can be used to join the cooker bowl and the cover together.
